(19) United States
(12) Patent Application Publication
(10) Pub. No.: US 2013/0193734 A1
(43) Pub. Date: Aug. 1, 2013

(54) SEAT ARRANGEMENT, VEHICLE SEAT, MOTOR VEHICLE AND METHOD FOR FOLDING A VEHICLE SEAT

(71) Applicant: GM Global Technology Operations LLC, Detroit, MI (US)

(72) Inventor: Andrzej PLESKOT, Trebur (DE)

(73) Assignee: GM GLOBAL TECHNOLOGY OPERATIONS LLC, Detroit, MI (US)

(21) Appl. No.: 13/748,192

(22) Filed: Jan. 23, 2013

(30) Foreign Application Priority Data
Jan. 25, 2012 (DE) 10 2012 001 277.2

(51) Int. Cl. B60N 2/22

(52) U.S. Cl. CPC B60N 2/22
USPC 297/354.1

(57) ABSTRACT

A seat arrangement includes a seat part, a backrest part, and an adjustment device. The adjustment device foldably connects the seat part with the backrest part. The adjustment device has a flexible transfer unit that is immovably fixed to the seat part and the backrest part. A vehicle seat with the seat arrangement, a motor vehicle with the vehicle seat, and a method for folding a backrest part of a vehicle seat relative to a seat part of the vehicle seat are also provided.

### CROSS-REFERENCE TO RELATED APPLICATION

This application claims priority to German Patent Application No. 10 2012 001 277.2, filed Jan. 25, 2012, which is incorporated herein by reference in its entirety.

### TECHNICAL FIELD

The technical field relates to a seat arrangement encompassing at least one adjustment device that foldably connects two parts with each, a vehicle seat, a motor vehicle, and a method for folding a vehicle seat.

### BACKGROUND

Seat arrangements for motor vehicles with cables and/or lines secured thereto are generally known. The known seat arrangements usually exhibit a seatback and a backrest section that are foldably connected by means of a folding mechanism or adjustment device, more precisely a backrest adjustment device. In the known embodiments, the cables and/or lines run between the seatback and seat part in the area of the adjustment device. When folding the seatback toward the seat part or away from the seat part, the cables and/or lines, generally referred to as transfer units, are bent or kinked or stretched beyond their natural bending radius, especially in the area of the folding mechanism. Furthermore, the fixations often form sharp edges, against which the transfer units abut. While folding, the transfer units can slide along these sharp edges and be damaged in the process, thus potentially having a negative influence on their function. This must be avoided in particular in the case of safety-relevant cables, for example for triggering a side airbag on the seat arrangement.

Therefore, at least one object herein is to provide a seat arrangement with an array or routing of cables and/or lines that is also flexible during a folding movement of the seat arrangement so that damage to the cables or lines is avoided. It is also desirable to provide a vehicle seat and motor vehicle as well as a method for this purpose. In addition, other objects, desirable features and characteristics will become apparent from the subsequent summary and detailed description, and the appended claims, taken in conjunction with the accompanying drawings and this background.

### SUMMARY

In an exemplary embodiment, a seat arrangement, for example, a vehicle seat of a motor vehicle, is provided. The seat arrangement includes, for example an at least two-part, adjusting device, which foldably joins two parts together, and a flexible transfer unit. The transfer unit is immovably fixed to the respective parts. Such a seat arrangement ensures a progression by the transfer unit in the area of the adjusting device, which remains flexible even given a folding movement of the seat arrangement, so that the transfer unit is not damaged.

The seat arrangement encompasses a seat part and a seatback or backrest part foldably connected with the seat part. The seatback or backrest part is folded by the adjustment device, also referred to as a backrest adjustment device, which correspondingly joins the seatback with the seat part. In an embodiment, exactly one adjustment device is provided. Other embodiments provide for more than one, for example two or three, adjustment devices. Each seat arrangement preferably exhibits two adjustment devices, for example an adjustment device on either side of the seat arrangement. In an embodiment, the seatback and seat part are directly and foldably connected with each other. In other embodiments, the seatback and seat part are foldably connected with each other by nterspersed adapter sections. For example, the adapter sections are designed as a(n adapter) section on the seat part side and a(n adapter) section on the backrest side.

The adjustment device has a multipart design so as to enable a reliable folding of components. In particular, the adjustment device exhibits a seat part side part, and a backrest side part. In an embodiment, the seat part side part is integrated into the seat part and/or the backrest side part is integrated into the backrest or seatback. In other embodiments, the parts are separately configured, e.g., attached to the seat part or backrest part or connected therewith.

In an embodiment, the seat part side part is connected with the seat part or integrated into the latter. The backrest side part is connected with the seatback or integrated into the latter. In an embodiment, the backrest side part is connected with a bearing structure of the backrest part, in particular with a backrest shell part of the seatback. Both parts are in turn connected with each other so that they can turn or fold around a rotational axis, for example via the metal mount of a backrest adjustment device. For example, the adjustment device exhibits a (pivot) joint, hinge or the like. The backrest adjustment device preferably exhibits a rotational axis around which the backrest part can rotate or fold relative to the seat part. Latching elements of the device inhibit folding.

In another embodiment, the transfer unit is used to transfer and/or relay signals or parameters between at least two components. For example, the transfer unit is used to activate a side airbag on the seat arrangement, or is configured as a heater cable. The transfer unit is preferably only loaded on tension. Given a pressure in the longitudinal direction of the transfer unit, the transfer unit bends. Understood by the term transfer unit, for example, are any cables, hoses, lines, wires, harnesses and the like that run on the seat arrangement in the area of the adjustment device, preferably from the seatback toward the seat part and back, and that bend when exposed to pressure.

The transfer unit runs from the backrest side part, backrest part for short, to the seat part side part, seat part for short, in an embodiment. The transfer unit here runs between the seat part and seatback, at least partially in the area of the adjustment device. The transfer unit preferably runs from an interior side of the seat part to an interior side of the backrest part. In other embodiments, the transfer unit runs from an exterior side of the seat part to an exterior side of the backrest part. In still other embodiments, the transfer unit runs from an exterior side of the seat part to an interior side of the backrest part or vice versa. The transfer unit is only curved, and runs without kinks. A maximum bending radius for the transfer unit here corresponds to a natural bending radius that is possible without breaking off the transfer unit. As a consequence, the transfer unit runs in the widest possible curves and/or arcs to prevent it from snapping off during movement by the seat arrangement or from becoming damaged.

The transfer unit, in one embodiment, is immovably fixed to the foldable parts. The transfer unit is preferably secured by means of precisely two fastening elements. The two fastening elements yield an attachment of the transfer unit at two fastening points or sites, in particular a point attachment. The transfer unit is secured loosely at a maximum distance of the fastening elements, i.e., not in a taut or tensioned state.

An embodiment provides that a fastening element is formed on a seat part side part, in particular the adjustment device, and a fastening element is formed on a backrest side part, in particular the adjustment device. According to an embodiment, the fastening elements are immovably fixed to the seat part and backrest part. The fastening points of the transfer unit realized by the fastening elements are correspondingly spaced apart from each other thereon. The attachment of the transfer unit in the fastening elements is secured against moving, above all against sliding through. The transfer unit runs freely between the fastening elements, i.e., is unattached. For example, the fastening elements include clamps, clips, bushings, adhesive bonds and/or the like.

In an embodiment, because the fastening elements are arranged at the two parts that can be moved toward each other or the transfer unit is secured at two fastening points that can be moved toward each other, an arrangement or progression of the transfer unit between the fastening elements depends on a movement or a resultant distance between the fastening elements. The transfer unit preferably describes an approximately S-shaped progression between the fastening elements, at least when being folded together. The extent of the S-shape here depends on the distance between the fastening elements, meaning on a position of the parts or seat arrangement. In an extreme position of the seat arrangement, in an embodiment with the seatback folded (away) completely from the seat part, the distance between the fastening elements is maximal. The S-shape is here only flat and stretched. In another extreme position of the seat arrangement, preferably with the seatback folded completely toward the seat part, the distance between the fastening elements is minimal The transfer unit is here squeezed together, and its S-shape is more strongly pronounced. The bending radius of the transfer unit here maximally corresponds to a natural, kink-free bending radius. In order to prevent damage to the transfer unit with the seatback folded back, one embodiment provides that a maximal distance between the fastening elements be less than or equal to a length of the transfer unit between the fastening elements. This ensures that the transfer unit does not become overstretched and damaged in the process. The transfer unit is preferably slack in this state. For example, the transfer unit sags a little, and thus exhibits only a mild S-shape or mild slight C-shape with a slight curvature.

In an embodiment, the distance between the fastening elements varies with the movement of the seat arrangement between the extreme positions. If the fastening elements are spaced farther apart or move away from each other while folding the seatback away from the seat part, the curvature becomes weaker. In other words, the S-shape becomes stretched or narrower and longer. As a consequence, the two S-arcs become flatter. By contrast, the curvature is strengthened when the fastening elements move toward each other, i.e., when the seatback is folded in the direction of the seat part. The S-shape becomes wider and shorter as a result. The S-arcs here become rounder and narrower. When the S-shape is squeezed together, the S-arcs are preferably compressed or deformed only to the maximum, natural bending radius of the transfer unit. The transfer unit is freely movable and unattached between the fastening elements that move toward or away from each other when being folded, so that the S-shape can be flexibly formed and changed. This prevents damage when folding the seat arrangement.

In another embodiment, a guide, in particular a curvature guide, is provided to induce a curved, in particular C-shaped or S-shaped, progression of the transfer unit. The curvature guide helps the transfer unit curve while folding the seat arrangement, preferably when the fastening elements are to be moved toward each other. As the distance diminishes, the curvature guide facilitates the formation of the S-shape. However, the transfer unit is not held or fixed in place by the curvature guide in the process, but rather only abuts against the latter so as to gain its flexibility in changing the S-shape.

In an embodiment, the curvature guide is at least partially integrated into the parts, for example in the form of arc-shaped elevations and/or depressions. Other embodiments provide a separate design for the curvature guide. A curvature guide is preferably on hand for each S-arc of the transfer unit.

In another embodiment, the (curvature) guide is integrated into at least one fastening element. For example, the fastening elements exhibit an oblong shape, which ensures an alignment of the transfer unit in one direction. This alignment of the transfer unit by means of the fastening elements or curvature guide facilitates the formation of the S-shape for the transfer unit in the folding process.

For this reason, an embodiment provides that the fastening elements be aligned differently at least given a maximum distance between the fastening elements, so that a progression of the transfer unit deviates from a connecting line between the fastening elements. For example, the transfer unit then follows a C-shaped or preferably S-shaped progression.

In yet another embodiment, a gap guide is provided to guide the transfer unit in a gap between the parts. The transfer unit advantageously runs in a gap between the parts in the area of the adjustment device. The gap advantageously extends parallel to a longitudinal and vertical extension of the seatback. The fastening elements are advantageously situated inside this gap, so that the gap guide is realized by the gap. The curvature of the transfer unit is preferably changed inside this gap. This is ensured by the gap guide. The gap guide or the gap here ensures a certain tolerance laterally to a central plane of the gap.

In an embodiment, the gap guide is integrated into the parts. In other embodiments, the gap guide is formed between the parts, in particular in the gap. Another embodiment provides for an at least partial integration of the curvature guide and gap guide. This makes it possible to avoid additional components and/or a complicated design for the parts. Yet another embodiment envisages that the gap guide be integrated into the lining of the backrest part and/or seat part. In addition, the transfer unit is not visibly covered to the outside by this. For example, the gap guide takes the form of projections, pins, etc.

Another embodiment provides that several transfer units are on hand. For example, two, three or four transfer units are furnished in an embodiment. A transfer unit is provided on each side of the seat arrangement, for example. For example, a transfer unit is comprised of several harnesses, in particular cable elements or harnesses. The harnesses preferably run parallel.

For example, several line elements and/or several cable elements can here be arranged in the one gap between the parts by the curvature and/or gap guide. The line and/or cable elements can be situated parallel, side-by-side, and/or one atop the other so as to realize a compact structural design. Transfer units or cable elements with a smaller natural or kink-free bending radius are advantageously situated on the inside.

In another exemplary embodiment, a vehicle seat with a seat structure configured as a seat arrangement described above is provided. In addition to the seat arrangement, the vehicle seat exhibits a respective seat cushion and seat cover on the backrest part and seat part. The transfer unit is covered by the seat cover or seat cushion, for example by a lining. As a result, the latter is not visible to the user.

In a further embodiment, a motor vehicle with a vehicle seat as described above is provided. For example, the motor vehicle is a sedan, station wagon, couple, all-terrain vehicle, (mini)bus or the like. The motor vehicle encompasses several of the seat arrangements described above, with the transfer units arranged as described above, for example as a driver, front-seat passenger and/or back seat (bench). This ensures any functions of the motor vehicle in the area of the vehicle seats, e.g., seat heating and/or side airbag.

Given a vehicle seat aligned in the traveling direction, the gap between the parts or between the seatback and seat part in which the S-shaped transfer unit is situated preferably runs transverse to a longitudinal axis of the vehicle.

In yet another embodiment, a method for folding a vehicle seat, in particular for folding a seat part side part relative to a backrest side part of the vehicle seat, is provided. A transfer unit is immovably fixed to the seat part side part and the backrest side part is at least partially bent and/or stretched in the folding process. Use is here preferably made of a bending characteristic of the oblong, flexible transfer unit, which causes the transfer unit to bend when exposed to a pressure.

### BRIEF DESCRIPTION OF THE DRAWINGS

The various embodiments will hereinafter be described in conjunction with the following drawing figures, wherein like numerals denote like elements, and wherein:

FIGS. 1a-1c are respectively varying, schematic views of a section of a seat arrangement in the area of an adjustment device, in accordance with an exemplary embodiment;

FIGS. 2a and 2b are a side view of the section of FIG. 1a-1c and a further magnified view with the seat arrangement in a first position, respectively; and

FIGS. 3a and 3b is another side view of the section of FIG. 1a-1c and a further magnified section with the seat arrangement in a different position, respectively.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

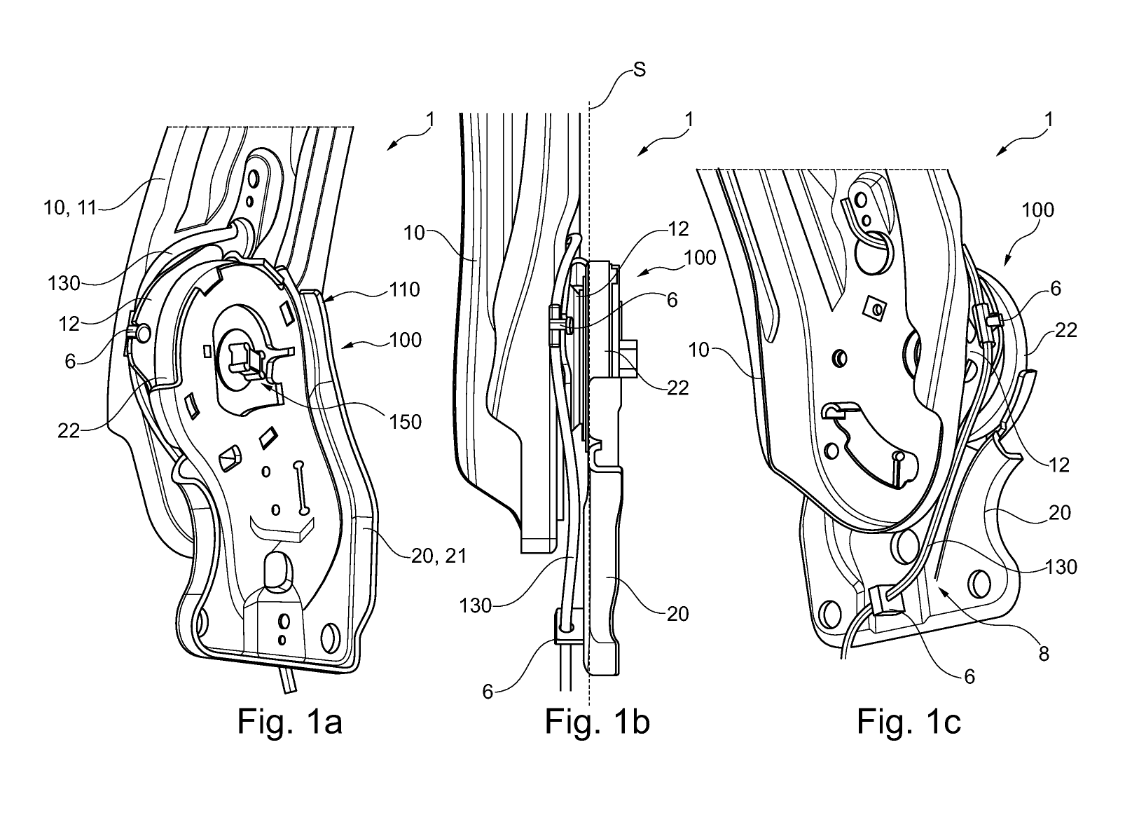

FIGS. 1a-1c, 2a, 2b and 3a, 3b each show different views of a section of a seat arrangement 1 in the area of an adjustment device 100. The seat arrangement 1 in these embodiments is configured as the bearing structure of a vehicle seat, wherein only the components important for a direct understanding of the invention are shown. The seat arrangement 1 here encompasses the adjustment device 100, which foldably connects a seatback side part, backrest part 10 for short, with a seat part side part, seat part 20 for short, of the seat arrangement 1. In the embodiment depicted here, the backrest part 10 encompasses a backrest shell part or seat part section 11, for example which can also be designed as the bearing structure. The backrest part 10 further encompasses a backrest adapter part, or backrest adapter 12 for short. The backrest adapter 12 can be integrated into the backrest section 11 or backrest part 10. In the embodiment illustrated, the backrest adapter 12 is configured as a separate part, which is connected with the backrest section 11. The seat part 20 further encompasses a seat adapter part, or seat adapter 22 for short. The seat adapter 22 can be integrated into a seat section 21 or seat part 20. In the embodiment illustrated, the seat adapter 22 is configured as a separate part, which is connected with the seat section 21.

The two parts 12 and 22 are connected with each other via a metal mount of a locking device 110 so that they can fold or turn around a rotational axis 150 of the locking device 110.

The seat arrangement 1 further encompasses a transfer unit 130, which in this embodiment is a tensile element, or as a rope-like element, here as a cable, for example to trigger a side airbag of the seat arrangement 1. The transfer unit 130 runs from the backrest part 10 to the seat part 20 or vice versa. The transfer arrangement 130 designed as a cable or also a line arrangement runs between the backrest part 10 and seat part 20 in the area of the adjustment device 100. According to an embodiment, the transfer unit 130 is immovably fixed to the adjustment device 100 by means of two fastening elements 6. One fastening element 6 is here arranged on the backrest part 10, more precisely on the backrest adapter 12. Another fastening element 6 is arranged on the seat part 20, more precisely on the seat adapter 22. The fastening elements 6 are spaced apart and immovably fix the transfer unit 130 on two fastening points or fastening sites spaced apart from each other. In the embodiment shown here, the fastening elements 6 secure the transfer unit 130 within a lateral gap S between the two at least partially laterally adjacent parts 12 and 22. The transfer unit 130 runs S-shaped in this gap S, wherein the S-shape is prescribed by the fastening elements 6, and the curvature depends on a distance between the fastening elements 6 and the length of the transfer unit 130.

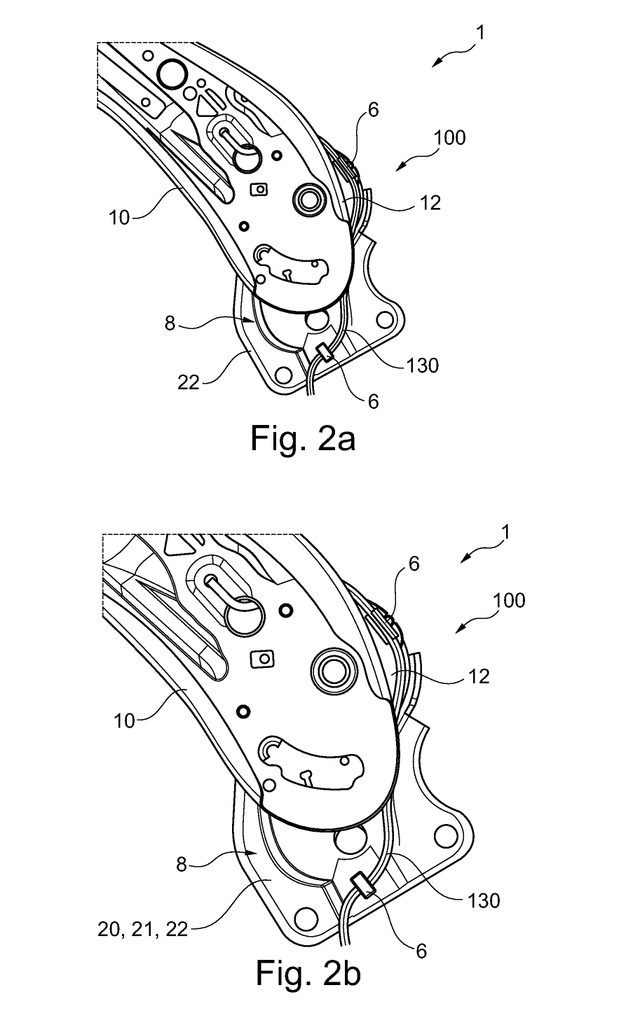

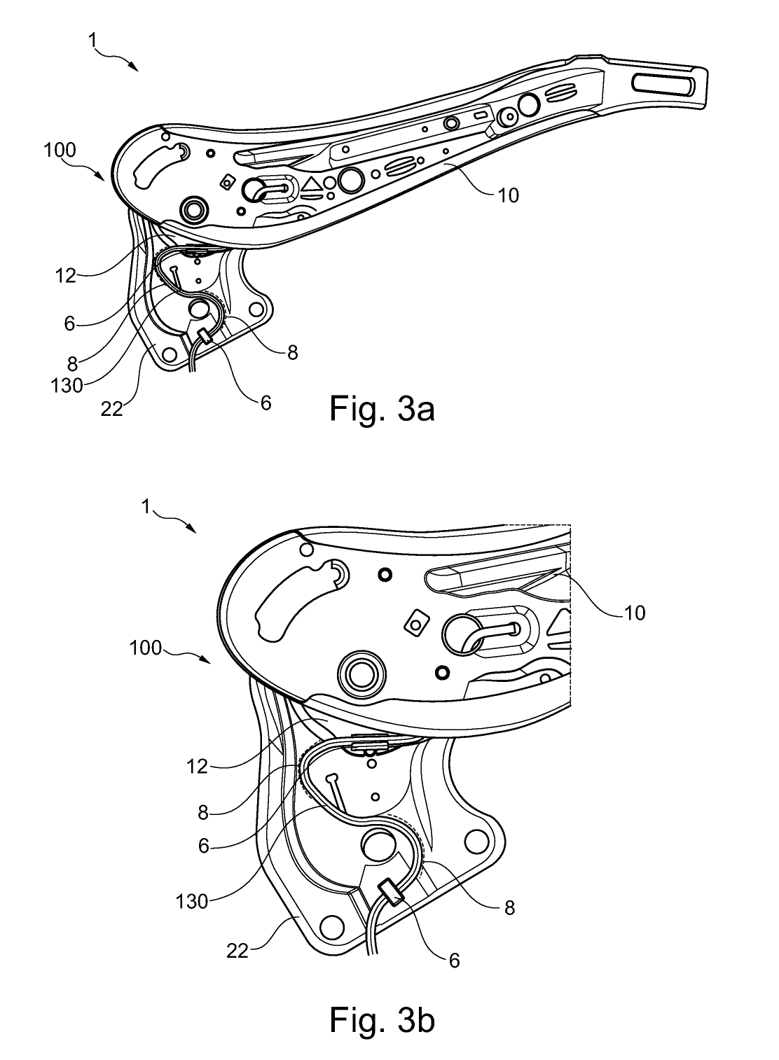

In an embodiment, the transfer unit 130 is unattached between the fastening elements 6, and thus partially mobile or flexible. The distance between the fastening elements 6 can be varied during a folding movement of the seat arrangement 1 by arranging the fastening elements 6 on the parts 12 and 22 that can move relative to each other. Depending on the distance between the fastening elements 6, the progression of the transfer unit 130 also changes (see FIGS. 2b and 3b). According to an embodiment, a maximum distance between the fastening elements 6 is smaller than a length of the transfer unit 130 between the fastening elements 6 (see FIG. 2b). This ensures that the transfer unit 130 is not overstretched or expanded. When the seat arrangement 1 is in a resting position, a distance between the fastening elements 6 is slightly less than a length of the transfer unit 130 between the fastening elements 6 (see FIG. 1c).

In another embodiment, the seat arrangement 1 further encompasses an integrated curvature or gap guide, referred to as a guide for short. The guide is here integrated into parts 12 and 22, and into the fastening elements 6. The guide is used to ease formation of the S-shaped progression of the transfer unit 130 while folding the backrest part 10. A more precise description of the guide follows on FIGS. 3a and 3b.

FIGS. 1a-1c each show respectively varying, schematic views of a section of the seat arrangement 1 in the area of an adjustment device 100. FIG. 1a presents a lateral, perspective view from the direction of the seat part 20. FIG. 1b presents a rear view of the section of the seat arrangement 1. And FIG. 1c presents a different lateral perspective view from the direction of the backrest part 10. The rear view according to FIG. 1b clearly depicts the gap S between the parts 12 and 22, and the progression of the transfer unit 130 herein. The guide 8 is also more clearly discernible from FIG. 1c. The guide is here designed as a molded recess on the seat adapter 22. In addition, the guide is realized by the holding fixture for the transfer unit 130 on the fastening elements 6. The holding fixture is here designed as a transfer unit guide. The channel-like guide provides a progression for the transfer unit 130 through the fastening elements 6.

FIGS. 2a and 3a each show a respective schematic side view of the section on FIG. 1a-1c with the seat arrangement 1 in various positions. The accompanying FIGS. 2b and 3b each show a further magnified section in the area of the adjustment device 100. FIGS. 2a and 2b depict the seat arrangement 1 in a first extreme position, with the backrest part 10 folded back, i.e., folded away from the seat part 20. The distance between the fastening elements 6 is here at a maximum. The transfer unit 130 is situated in such a way as to exhibit a slightly S-shaped, curved progression. Accordingly, the distance between the two fastening elements 6 is a little smaller than the accompanying length of the transfer unit 130 between the two fastening elements. The curvature of the transfer unit 130 is supported by the guide, which facilitates the progression of the transfer unit 130 on the fastening elements on the one hand, and the progression inside the gap S on the other.

By contrast, FIGS. 3a and 3b show the seat arrangement 1 in another extreme position, with the backrest part 10 folded to the front, i.e., folded toward the seat part 20. The distance between the fastening elements is here minimal The S-shape of the transfer unit 130 is highly pronounced, in particular squeezed together relative to the S-shape according to FIGS. 2a and 2b, with distinct S arcs. The attachment at points or places on the two fastening elements 6 enable a flexible change in the shape or progression of the transfer unit 130 within the gap S between the fastening elements 6. However, the transfer unit 130 is here not kinked or overstretched. Rather, the transfer unit 130 is curved within a prescribed bending radius, for example which can be dictated by material. Furthermore, FIGS. 3a and 3b show the guide 8 of the transfer unit 130 in the area of the seat part 20. In this embodiment, the guide 8 is on the one hand integrated into the seat part 20 or seat adapter 22 in the form of elevations or depressions, and here denoted with dashed lines. On the other hand, the guide 8 is integrated into the fastening elements 6. The oblong fastening elements 6 form a guide for the transfer unit 130 as the result of their alignment. The fastening elements 6 are here varyingly aligned, so that there is an S-shaped deviation between the progression of the transfer unit 130 and a connecting line between the fastening elements 6.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A seat arrangement comprising:
a seat part;
a backrest part;
an adjustment device that foldably connects the seat part with the backrest part, the adjustment device having a flexible transfer unit, wherein the flexible transfer unit is immovably fixed to the seat part and the backrest part.

2. The seat arrangement according to claim 1, wherein the seat arrangement is a vehicle seat of a motor vehicle.

3. The seat arrangement according to claim 1, wherein a first fastening element is formed on a seat part side part of the seat part, and a second fastening element is formed on a backrest side part of the backrest part.

4. The seat arrangement according to claim 3, wherein a maximum distance between the first fastening element and the second fastening element is less than or equal to a length of the flexible transfer unit between the first and second fastening elements.

5. The seat arrangement according to claim 1, wherein the adjustment device comprises a guide to induce a curved progression of the flexible transfer unit.

6. The seat arrangement according to claim 5, wherein the guide is configured to induce a C-shaped or S-shaped curved progression of the flexible transfer unit.

7. The seat arrangement according to claim 5, wherein the guide is integrated into a fastening element.

8. The seat arrangement according to claim 3, wherein the first fastening element and the second fastening element are aligned differently at least given a maximum distance between the fastening elements so that a progression of the flexible transfer unit deviates from a connecting line between the first and the second fastening elements.

9. The seat arrangement according to claim 1, wherein the adjustment device comprises a gap guide configured to guide the flexible transfer unit in a gap between the seat part and the backrest part.

10. The seat arrangement according to claim 1, wherein the adjustment device comprises a plurality of flexible transfer units.

11. A vehicle seat with a seat structure comprising:
a seat part;
a backrest part; and
an adjustment device that foldably connects the seat part with the backrest part, the adjustment device having a flexible transfer unit, wherein the flexible transfer unit is immovably fixed to the seat part and the backrest part.

12. A motor vehicle with a vehicle seat, the vehicle seat having a seat structure comprising:
a seat part;
a backrest part; and
an adjustment device that foldably connects the seat part with the backrest part, the adjustment device having a flexible transfer unit, wherein the flexible transfer unit is immovably fixed to the seat part and the backrest part.

13. A method for folding a backrest part of a vehicle seat relative to a seat part of the vehicle seat, the method comprising the steps of:
at least partially bending and/or stretching a transfer unit immovably fixed to a seat part side part and a backrest side part of the vehicle seat.
